(19) United States
(12) Patent Application Publication
(10) Pub. No.: US 2025/0020927 A1
(43) Pub. Date: Jan. 16, 2025

(54) IMAGE LIGHT GUIDE HAVING HIGH-INDEX OUTER LAYERS

(71) Applicant: Vuzix Corporation, West Henrietta, NY (US)

(72) Inventor: Robert J. Schultz, Victor, NY (US)

(21) Appl. No.: 18/711,387

(22) PCT Filed: Nov. 18, 2022
(86) PCT No.: PCT/US2022/050437

§ 371 Date: May 17, 2024

Related U.S. Application Data
(60) Provisional application No. 63/281,452, filed on Nov. 19, 2021.

(51) Int. Cl. G02B 27/01; F21V 8/00; G02B 27/00

(52) U.S. Cl. CPC G02B 27/0172; G02B 6/0016; G02B 6/0038; G02B 6/0065; G02B 27/0081; G02B 2027/0174; G02B 2027/0178

(57) ABSTRACT

An image light guide having a planar waveguide including a transmissive substrate having a first refractive index and at least one outer layer of transmissive material having a second refractive index, wherein the second refractive index is higher than the first refractive index. The transmissive substrate including a front surface and a back surface, wherein the at least one outer layer of a transmissive material is engaged with at least one of the front and back surfaces of the transmissive substrate. The image light guide further including at least one of an in-coupling optic and an out-coupling optic formed in or on the at least one outer layer of transmissive material, wherein the at least one of the in-coupling optic and the out-coupling optic is operable to couple image-bearing light beams into or out of the planar waveguide, respectively.

### TECHNICAL FIELD

The present disclosure relates generally to electronic displays and more particularly to near-eye displays that use image light guides to convey image-bearing light beams to a viewer.

### BACKGROUND

Head-mounted near-eye displays, which may take the binocular form of eyeglasses or the monocular form of suspended eyepieces, can include an image generator and an image light guide for presenting virtual images to a wearer's eyes. The image light guides can be arranged with an in-coupling optic and an out-coupling optic incorporated into a transparent waveguide for conveying the virtual images in an angularly encoded form from an offset position of the image generator to a position aligned with the wearer's eye. The transparent waveguide can also provide an aperture through which the wearer can simultaneously view the real world, particularly in support of augmented reality (AR) applications in which the virtual images are superimposed on the real world scene.

While the transparent waveguide can be shaped in different ways, such as for contributing optical power, waveguides having a thin plate-shaped form provide both functional and manufacturing advantages. For example, plate-shaped waveguides with plane-parallel front and back surfaces provide a reliable way of preserving the angular encoding of beams propagating by the mechanism of total internal reflection (TIR) between the in-coupling and out-coupling optics. The plate-shaped form is also easier to manufacture to high tolerances and can reduce the size, weight, and cost of the image light guides.

Similar to other optics, waveguides made of higher refractive index materials provide certain advantages because of their higher refractive index contrast with surrounding air. For example, diffractive optics formed as surface relief gratings on the plate-shaped waveguides can support larger angular and spectral bandwidths. As such, image light guides with higher index waveguides can support wider fields of view and more uniform color profiles.

However, high refractive index materials tend to be more expensive and can also include other drawbacks relating to issues of transmissivity, weight, and appearance. In addition, index matching adhesives for the higher index materials are rarer, and if available, can further add to cost. Thus, while the optical capabilities of higher index materials are desirable, the various drawbacks of higher index materials militate against their use in image light guides.

### SUMMARY

One or more embodiments of an image light guide feature a composite waveguide that both preserves the lower cost and manufacturing advantages of lower refractive index materials while enjoying certain performance advantages of higher refractive index materials. The base substrate of the waveguide can be made of conventional glass or plastic with plane parallel front and back surfaces. A high-index polymer or other high index material can be applied to the base substrate so that one or more of the front or back surfaces of the waveguide exposed to air are made of a higher refractive index material.

Alternatively, the base substrate can be made to less exacting standards and the front or back surfaces of the base substrate can be modified for improved optical smoothness, flatness or parallelism by applying coatings of an index matching material. The higher refractive index material can be applied over the lower index matching material to improve optical smoothness, flatness, and/or parallelism between the front and back surfaces of the waveguide as well as with the interfaces between the lower and higher index materials.

Advantageously, diffraction gratings can be formed in or on the outer surfaces as in-coupling, turning, or out-coupling optics. The higher index material of the outer surfaces used for forming the periodic features of the gratings supports greater phase shifts with respect to the surrounding air, which allows the gratings to be made with shallower grating profiles. In addition, the higher index material can increase grating efficiency and allow for expanding grating performance over a wider ranges of angles and wavelengths. Refraction of the light at the interface between the lower and higher index materials can also reduce the amount of diffraction required for directing light into or out of the waveguide.

An image light guide for a near-eye display system according to one embodiment features a planar waveguide including a transmissive substrate having a given refractive index and at least one outer layer of transmissive material having a higher refractive index. The transmissive substrate has front and back surfaces, and the at least one outer layer of a transmissive material is coupled with at least one of the front and back surfaces of the transmissive substrate. At least one of an in-coupling diffractive optic and an out-coupling diffractive optic are formed in or on the at least one outer layer for respectively diffracting image-bearing light beams into or out of the planar waveguide.

The at least one outer layer can include a first outer layer coupled with the front surface of the transmissive substrate and a second outer layer coupled with the back surface of the transmissive substrate. The at least one of the in-coupling diffractive optic and the out-coupling diffractive optic can include both the in-coupling and out-coupling diffractive optics being formed in or on the at least one of the first and second outer layers. The first and second outer layers preferably include respective front and back plane parallel surfaces that are exposed to air.

At least one of the front and back surfaces of the transmissive substrate can depart from being at least one of optically smooth, flat, and plane parallel. Additionally, at least one intermediate layer of a transmissive material having a refractive index matching the refractive index of the transmissive substrate can be applied the transmissive substrate. Furthermore, the at least one intermediate layer can have at least one of a front surface and a back surface that is optically smooth, flat, and plane parallel to compensate for the departure of the at least one of the front and back surfaces of the transmissive substrate. The at least one intermediate layer is preferably located between the transmissive substrate and the at least one outer layer.

The at least one intermediate layer can include a first intermediate layer adjacent to the front surface of the transmissive substrate and a second intermediate layer adjacent to the back surface of the transmissive substrate. The first and second intermediate layers can include respective front and back surfaces that are optically smooth, flat, and plane parallel.

The at least one outer layer can include a first outer layer adjacent to the front surface of the first intermediate layer and a second outer layer adjacent to the back surface of the second intermediate layer. The first and second outer layers preferably include respective front and back surfaces that are optically smooth, flat, and plane parallel.

The at least one of the in-coupling and out-coupling diffractive optics can be a diffraction grating having diffractive features formed at differential depths in or on the at least one outer layer. Preferably the diffraction grating is spaced apart from an interface between the transmissive substrate and the at least one outer layer so that refraction at the interface reduces the amount of diffraction required for directing light into or out of the waveguide. The refractive index of the transmissive substrate can be 1.6 or less and the refractive index of the at least one outer layer can be greater than or equal to 1.7.

An image light guide for a near-eye display system according to another embodiment includes a planar waveguide and in-coupling and out-coupling optics for respectively directing image-bearing light beams into and out of the waveguide. The planar waveguide includes a transmissive substrate having front and back surfaces, at least one intermediate layer of a transmissive material adhered to at least one of the front and back surfaces of the transmissive substrate, and at least one outer layer of a transmissive material adhered to the at least one intermediate layer. The at least one intermediate layer has a refractive index that matches a refractive index of the transmissive substrate. The at least one outer layer has a refractive index that is greater than the matching refractive index of the at least one intermediate layer and the transmissive substrate.

The at least one of the front and back surfaces of the transmissive substrate can depart from being at least one of optically smooth, flat, and plane parallel. However, the at least one intermediate layer has at least one of a front surface and a back surface that is optically smooth, flat, and plane parallel to compensate for the departure of the at least one of the front and back surfaces of the transmissive substrate. The at least one intermediate layer can include a first intermediate layer adhered to the front surface of the transmissive substrate and a second intermediate layer adhered to the back surface of the transmissive substrate. The first and second intermediate layers preferably include respective front and back surfaces that are optically smooth, flat, and plane parallel.

The at least one outer layer can include a first outer layer adhered to the front surface of the first intermediate layer and a second outer layer adhered to the back surface of the second intermediate layer. The first and second outer layers preferably include respective front and back surfaces that are optically smooth, flat, and plane parallel. The refractive index of the transmissive substrate and the at least one intermediate layer can be 1.6 or less and the refractive index of the at least one outer layer can be greater than 1.6 or more preferably greater than or equal to 1.7.

A method of making an image light guide for a near-eye display according to another embodiment provides for coating a transmissive substrate having a given refractive index with at least one outer layer of transmissive material having a higher refractive index for forming a planar waveguide. At least one of an in-coupling diffractive optic and an out-coupling diffractive optic are formed in or on the at least one outer layer.

The at least one of the in-coupling and out-coupling diffractive optics is preferably a diffraction grating having diffractive features formed at differential depths in or on the at least one outer layer and is spaced apart from an interface between the transmissive substrate and the at least one outer layer so that refraction at the interface reduces the amount of diffraction required for directing light into or out of the waveguide. The step of coating can include coating the transmissive substrate with at least one intermediate layer having a refractive index matching the refractive index of the transmissive substrate and then coating the at least one intermediate layer with the at least one outer layer so that one or more interfaces between the at least one outer layer and the at least one intermediate layer are formed parallel to one or more outer surfaces of the one or more outer layers.

### BRIEF DESCRIPTION OF THE DRAWING FIGURES

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a schematic side view of an image light guide of a near-eye display system with an exaggerated thickness for showing the propagation of light from an image source along the image light guide to an eyebox within which the virtual image can be viewed.

FIG. 2 is a schematic perspective view of an image light guide of a near-eye display system including an in-coupling diffractive optic, a turning diffractive optic, and out-coupling diffractive optic for managing the propagation of image-bearing light beams.

FIG. 3 is a schematic perspective view of another image light guide having an array of reflectors as a turning optic.

FIG. 4A is a schematic side view of an image light guide including outer layers of a transmissive material having a higher refractive index than a base substrate.

FIG. 4B is a schematic side view of a portion of an image light guide according to FIG. 4A, showing the propagation of light along the image light guide and refraction at the surfaces of the base substrate.

FIG. 5 is a schematic side view of an image light guide including intermediate layers made of a transmissive material having a refractive index matching the refractive index of a base substrate for correcting the form of the base substrate and outer layers of a transmissive material having a higher refractive index than a base substrate.

FIG. 6 is a schematic perspective view showing a near-eye display system for augmented reality viewing using image light guides according to the present disclosure.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Where used herein, the terms “first”, “second”, and so on, do not necessarily denote any ordinal, sequential, or priority relation, but are simply used to more clearly distinguish one element or set of elements from another, unless specified otherwise.

Where used herein, the terms “front”, “back”, and so on, do not necessarily denote any spatial relation, but are simply used to more clearly distinguish one element or set of elements from another, unless specified otherwise.

Where used herein, the terms “viewer”, “operator”, “observer”, “wearer”, and “user” are considered equivalents and refer to the person, or machine, that wears and/or views images using a device having an imaging light guide.

Where used herein, the term “set” refers to a non-empty set, as the concept of a collection of elements or members of a set is widely understood in elementary mathematics. Where used herein, the term “subset”, unless otherwise explicitly stated, refers to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the term “beam expansion” is intended to mean replication of a beam via multiple encounters with an optical element to provide exit pupil expansion in one or more dimensions. Similarly, as used herein, to “expand” a beam, or a portion of a beam, is intended to mean replication of a beam via multiple encounters with an optical element to provide exit pupil expansion in one or more dimensions.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

Where used herein, the term “substantially” is intended to mean within the tolerance range of the equipment used to produce the value, or, in some examples, is intended to mean plus or minus 10%, or plus or minus 5%, or plus or minus 1%, unless otherwise expressly specified.

Where used herein, the term “exemplary” is intended to mean “an example of,” “serving as an example,” or “illustrative,” and does not denote any preference or requirement with respect to a disclosed aspect or embodiment.

As described intra, an image generator can take a number of forms including back-lit, front-lit, or light generating displays combined with focusing optics for converting spatial information into substantially collimated angularly related beams. Alternatively, the image generator can be arranged as a beam scanning device to angularly direct light from a source of substantially collimated light. The two dimensions of the images can also be separately generated such as by a combination of a linear display with a beam scanning device.

An in-coupling optic, which can take a variety forms including prisms, mirrors, or diffractive optics, directs the angularly related beams from the image generator into the waveguide. For example, such diffractive optics can be formed as diffraction gratings or holographic optical elements that can be mounted on the front or back surface of the planar waveguide or formed in the waveguide.

An out-coupling optic can take similar forms as the in-coupling optic, but to preserve a view of the ambient environment through the waveguide, the out-coupling optic should avoid distorting or otherwise impairing the wearer's view of the real world. As a diffractive optic, the out-coupling optic can be matched with the in-coupling diffractive optic to decode any angular encoding imposed by the in-coupling diffractive optic. In addition, the efficiency of the outcoupling diffractive optic can be controlled to support multiple encounters with the angularly related beams propagating along the waveguide in one or more directions to effectively replicate each beam in at least one direction such that beams diffracted from the waveguide overlap over a larger area within which the virtual image can be seen by the wearer's eye. This replication of a beam via multiple encounters with an optical element to provide exit pupil expansion in one or more directions may be referred to herein as beam expansion.

In addition to the in-coupling and out-coupling optics, an optional turning optic can also be formed along the waveguide, which can also be formed as a diffractive optic, for expanding the propagating light beams in a second dimension or for controlling the orientation of the light beams approaching the out-coupling optic. The in-coupling, turning, and out-coupling optics can be collectively designed so that the output of the image light guide as presented to the wearer, albeit dimensionally expanded, matches the angular relationships among the beams originating from the image generator. For example, the grating vectors of the diffractive optics can sum to zero.

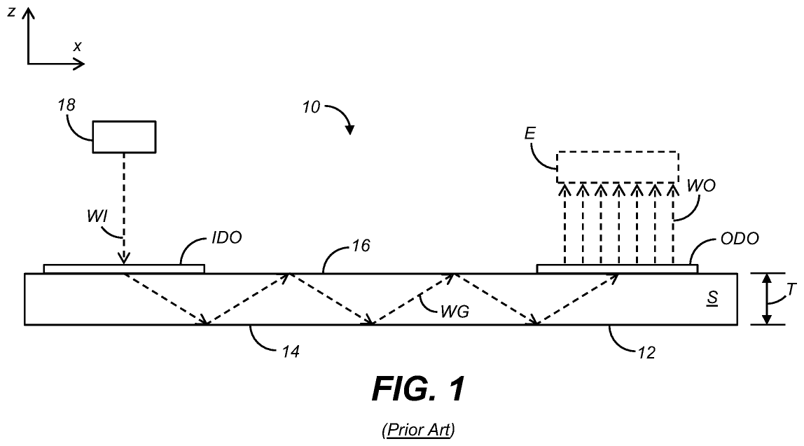

FIG. 1 is a schematic diagram showing a simplified cross-sectional view of one conventional configuration of an image light guide system 10. Image light guide system 10 includes a planar waveguide 12, an in-coupling diffractive optic IDO, and an out-coupling diffractive optic ODO. The planar waveguide 12 includes a transparent substrate S, which can be made of, for example, optical glass or plastic, with plane-parallel front and back surfaces 14 and 16. In this example, the in-coupling diffractive optic IDO is shown as a transmissive type diffraction grating arranged on the back surface 16 of the planar waveguide 12. However, in-coupling diffractive optic IDO could alternately be a reflective type diffraction grating or other type of diffractive optic, such as a volume hologram or other holographic diffraction element, that diffracts an incoming image-bearing light beams WI into the planar waveguide 12. The in-coupling diffractive optic IDO can be located on the front or back surface 14 or 16 of the planar waveguide 12 and can be of a transmissive or reflective type in a combination that depends upon the direction from which the image-bearing light beams WI approaches the planar waveguide 12.

When used as a part of a near-eye display system, the in-coupling diffractive optic IDO couples the image-bearing light beams WI from a real, virtual or hybrid image source 18 into the substrate S of the planar waveguide 12. Any real image or image dimension formed by the image source 18 is first converted, e.g., converged toward a focus, into an array of overlapping angularly related beams encoding the different positions within a virtual image for presentation to the in-coupling diffractive optic IDO. Typically, the rays within each bundle forming one of the angularly related beams extend in parallel, but the angularly related beams are relatively inclined to each other through angles that can be defined in two angular dimensions corresponding to linear dimensions of the image.

Once the angularly related beams engage with the in-coupling diffractive optic IDO, at least a portion of the image-bearing light beams WI are diffracted (generally through a first diffraction order) and thereby redirected by in-coupling diffractive optic IDO into the planar waveguide 12 as angularly encoded image-bearing light beams WG for further propagation along a length dimension X of the planar waveguide 12 by total internal reflection (TIR) from the plane parallel front and back surfaces 14 and 16. Although diffracted into a different combination of angularly related beams in keeping with the boundaries set by TIR, the image-bearing light beams WG preserve the image information in an angularly encoded form that is derivable from the parameters of the in-coupling diffractive optic IDO. The out-coupling diffractive optic ODO receives the encoded image-bearing light beams WG and diffracts (also generally through a first diffraction order) the image-bearing light beams WG out of the planar waveguide 12, as the image-bearing light beams WO, toward a nearby region of space referred to as an eyebox E, within with the transmitted virtual image can be seen by a viewer's eye. The out-coupling diffractive optic ODO can be designed symmetrically with respect to the in-coupling diffractive optic IDO to restore the original angular relationships of the image-bearing light beams WI among outputted angularly related beams of the image-bearing light beams WO. In addition, the out-coupling diffractive optic ODO can modify the original field points' positional angular relationships producing an output virtual image at a finite focusing distance.

However, to increase one dimension of overlap among the angularly related beams populating the eyebox E (defining the size of the region within which the virtual image can be seen), the out-coupling diffractive optic ODO is arranged together with a limited thickness T of the planar waveguide 12 to encounter the image-bearing light beams WG multiple times and to diffract only a portion of the image-bearing light beams WG upon each encounter. The multiple encounters along the length (e.g., a first direction) of the out-coupling diffractive optic ODO have the effect of replicating the image-bearing light beams WG and enlarging or expanding at least one dimension of the eyebox E where the replicated beams overlap. The expanded eyebox E decreases sensitivity to the position of a viewer's eye for viewing the virtual image.

The out-coupling diffractive optic ODO is shown as a transmissive type diffraction grating arranged on the back surface 16 of the planar waveguide 12. However, like the in-coupling diffractive optic IDO, the out-coupling diffractive optic ODO can be located on the front or back surface 14 or 16 of the planar waveguide 12 and can be of a transmissive or reflective type in a combination that depends upon the direction through which the image-bearing light beams WG is intended to exit the planar waveguide 12. In addition, the out-coupling diffractive optic ODO could be formed as another type of diffractive optic, such as a volume hologram or other holographic diffraction element, that diffracts propagating image-bearing light beams WG from the planar waveguide 12 as the image-bearing light beams WO propagating toward the eyebox E.

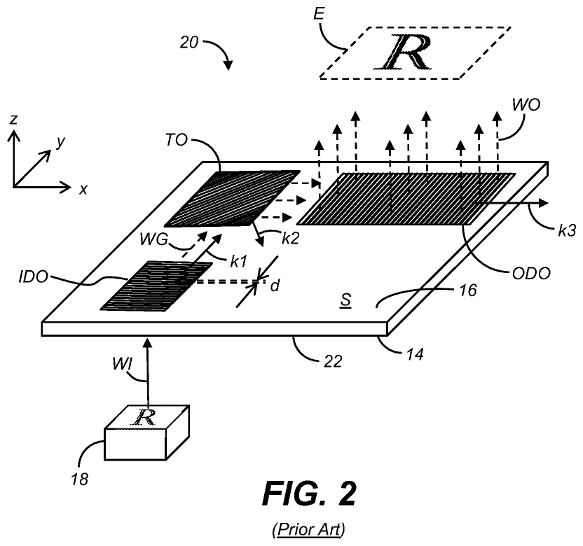

The perspective view of FIG. 2 shows an image light guide 20 that is arranged for expanding the eyebox E in two dimensions, i.e., along both x- and y-axes of the intended image. To achieve a second dimension of beam expansion, the in-coupling diffractive optic IDO is oriented to diffract the image-bearing light beams WG about a grating vector k1 along the planar waveguide 22 toward an intermediate turning optic TO, whose grating vector k2 is oriented to diffract the image-bearing light beams WG in a reflective mode along the planar waveguide 22 toward the out-coupling diffractive optic ODO. Only a portion of the image-bearing light beams WG are diffracted by each of multiple encounters with intermediate turning optic TO thereby laterally expanding each of the angularly related beams of the image-bearing light beams WG approaching the out-coupling diffractive optic ODO. The intermediate turning optic TO redirects the image-bearing light beams WG into an at least approximate alignment with a grating vector k3 of the out-coupling diffractive optic ODO for longitudinally expanding the angularly related beams of the image-bearing light beams WG in a second dimension before exiting the planar waveguide 22 as the image-bearing light beams WO. Grating vectors, such as the depicted grating vectors k1, k2, and k3, extend within a parallel plane of the planar waveguide 12 in respective directions that are normal to the diffractive features (e.g., grooves, lines, or rulings) of the diffractive optics and have respective magnitudes inverse to the period or pitch d (i.e., the on-center distance between the diffractive features) of the diffractive optics IDO, TO, and ODO.

With continued reference to FIG. 2, the in-coupling diffractive optic IDO receives the incoming image-bearing light beams WI containing a set of angularly related beams corresponding to individual pixels or equivalent locations within an image generated by the image source 18, such as a projector. A full range of angularly encoded beams for producing a virtual image can be generated by a real display together with focusing optics, by a beam scanner for more directly setting the angles of the beams, or by a combination such as a one-dimensional real display used with a scanner. The image light guide 20 outputs an expanded set of angularly related beams in two dimensions of the image by providing multiple encounters of the image-bearing light beams WG with both the intermediate turning optic TO and the out-coupling diffractive optic ODO in different orientations. In the depicted orientation of the planar waveguide 22, the intermediate turning optic TO provides beam expansion in the y-axis direction, and the out-coupling diffractive optic ODO provides a similar beam expansion in the x-axis direction. The relative orientations and respective periods d of the diffractive features of the in-coupling, intermediate turning, and out-coupling diffractive optics IDO, TO, and ODO provide for beam expansion in two dimensions while preserving the intended relationships among the angularly related beams of the image-bearing light beams WI that are output from the image light guide 20 as the image-bearing light beams WO.

That is, while the image-bearing light beams WI input into the image light guide 20 are encoded into a different set of angularly related beams by the in-coupling diffractive optic IDO, the information required to reconstruct the image is preserved by accounting for the systematic effects of the in-coupling diffractive optic IDO. The intermediate turning optic TO, located in an intermediate position between the in-coupling and out-coupling diffractive optics IDO and ODO, can be arranged so that it does not induce significant changes to the encoding of the image-bearing light beams WG. As such, the out-coupling diffractive optic ODO can be arranged in a symmetric fashion with respect to the in-coupling diffractive optic IDO, e.g., including diffractive features sharing the same period. Similarly, the period of the intermediate turning optic TO can also match the common period of the in-coupling and out-coupling diffractive optics IDO and ODO. Although the grating vector k2 of the intermediate turning optic TO is shown oriented at 45 degrees with respect to the other grating vectors, which remains a possible orientation, the grating vector k2 of the intermediate turning optic TO can be oriented at 60 degrees to the grating vectors k1 and k3 of the in-coupling and out-coupling diffractive optics IDO and ODO in such a way that the image-bearing light beams WG is turned 120 degrees. By orienting the grating vector k2 of the intermediate turning optic TO at 60 degrees with respect to the grating vectors k1 and k3 of the in-coupling and out-coupling diffractive optics IDO and ODO, the grating vectors k1 and k3 of the in-coupling and out-coupling diffractive optics IDO and ODO are also oriented at 60 degrees with respect to each other. Basing the grating vector magnitudes on the common pitch shared by the in-coupling, intermediate turning, and out-coupling diffractive optics IDO, TO, and ODO, the three grating vectors k1, k2, and k3 (as directed line segments) form an equilateral triangle, and sum to a zero vector magnitude, which avoids asymmetric effects that could introduce unwanted aberrations including chromatic dispersion. Such asymmetric effects can also be avoided by grating vectors k1, k2, and k3 that have unequal magnitudes in relative orientations at which the three grating vectors k1, k2, and k3 sum to a zero vector magnitude.

In a broader sense, the image-bearing light beams WI that are directed into the planar waveguide 22 are effectively encoded by the in-coupling optic, whether the in-coupling optic uses gratings, holograms, prisms, mirrors, or some other mechanism. Any reflection, refraction, and/or diffraction of light that takes place at the input should be correspondingly decoded by the output to re-form the virtual image that is presented to the viewer. Whether any symmetries are maintained or not among the intermediate turning optic TO and the in-coupling and out-coupling diffractive optics IDO and ODO or whether or not any change to the encoding of the angularly related beams of the image-bearing light beams WI takes place along the planar waveguide 12, the intermediate turning optic TO and the in-coupling and out-coupling diffractive optics IDO and ODO can be related so that the image-bearing light beams WO that are output from the planar waveguide 22 preserve or otherwise maintain the original or desired form of the image-bearing light beams WI for producing the intended virtual image.

The letter “R” represents the orientation of the virtual image that is visible to the viewer whose eye is in the eyebox E. As shown, the orientation of the letter “R” in the represented virtual image matches the orientation of the letter “R” as encoded by the image-bearing light beams WI. A change in the rotation about the z axis or angular orientation of incoming image-bearing light beams WI with respect to the x-y plane causes a corresponding symmetric change in rotation or angular orientation of outgoing light from out-coupling diffractive optic (ODO). From the aspect of image orientation, the intermediate turning optic TO simply acts as a type of optical relay, providing expansion of the angularly encoded beams of the image-bearing light beams WG along one axis (e.g., along the y axis) of the image. Out-coupling diffractive optic ODO further expands the angularly encoded beams of the image-bearing light beams WG along another axis (e.g., along the x axis) of the image while maintaining the original orientation of the virtual image encoded by the image-bearing light beams WI. The intermediate turning optic TO is typically a slanted or square grating or, alternately, can be a blazed grating and is typically arranged on one of the plane parallel front and back surfaces of the planar waveguide 22.

Together, the in-coupling diffractive optic IDO, turning optic TO, and out-coupling diffractive optic ODO preferably preserve the angular relationships among beams of different wavelengths defining a virtual image upon conveyance by an image light guide 20 from an offset position to a near-eye position of the viewer. While doing so, the in-coupling diffractive optic IDO, turning optic TO, and out-coupling diffractive optic ODO can be relatively positioned and oriented in different ways to control the overall shape of the planar waveguide 22 as well as the overall orientations at which the angularly related beams can be directed into and out of the planar waveguide 22.

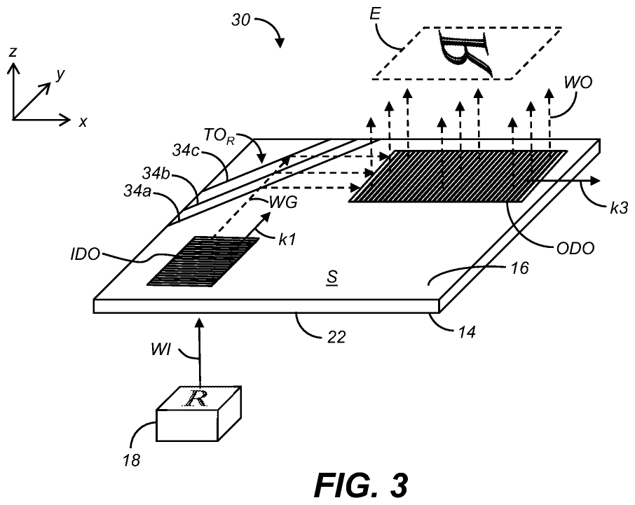

The perspective view of FIG. 3 shows an alternative version of an image light guide 30, which is also arranged for expanding the eyebox E in two dimensions. Like the previous embodiment, the image light guide 30 receives the incoming image-bearing light beams WI containing a set of angularly related beams corresponding to individual pixels or equivalent locations within an image generated by the image source 18. The in-coupling diffractive optic IDO diffracts the image-bearing light beams WI into the planar waveguide 22 for propagation by total internal reflection from the plane parallel front and back surfaces 14 and 16 of the planar waveguide 22 toward a turning optic TO_{R} in the form of a reflector array.

The turning optic TO_{R} is shown with three specularly reflective surfaces 34a, 34b, and 34c that extend through the planar waveguide 22 and are aligned in parallel to each other. While different numbers of reflective surfaces can be used, the three specularly reflective surfaces 34a, 34b, and 34c exhibit increasing amounts of reflectivity such that the reflective surfaces 34a and 34b are also decreasingly transmissive. As such, some of the light incident on reflector 34a is reflected toward the out-coupling diffractive optic ODO and other of the incident light is transmitted to reflector 34b. Similarly, some of the incident light reaching the reflector 34b is reflected toward the out-coupling diffractive optic ODO and other of the incident light is transmitted to the reflector 34c. Reflectivity increases for successive reflectors in the array as the reflectors are further separated from the in-coupling or out-coupling diffractive optics IDO, ODO. The last or rearmost reflector in the series, reflector 34c in the example of FIG. 3, has a nominal reflectance of 100%. Alternately, the last reflector in the series can operate as a type of filter, transmitting light of unwanted wavelengths to remove this light from the imaging system. The partial reflections, which also occur between the reflectors 34a, 34b, and 34c, further expand the angularly encoded light propagating along the planar waveguide 22 in the y dimension before approaching the out-coupling diffractive optic ODO, which expands the angularly encoded light in the x dimension. However, in contrast to the diffractive turning optic TO of the preceding embodiment, the reflective array of the turning optic TO_{R} has the effect of reversing and rotating the virtual image “R” as seen within the eyebox E. The image generated by the image source 18 as encoded by the incoming image-bearing light beams WI can be adjusted so that the image appearing within the eyebox E is oriented as intended.

The image light guides 10, 20, and 30 as described above are presented as examples of image light guides that are suitable for use in head-mounted displays (HMDs) designed for augmented reality (AR) applications in which virtual image content is superimposed on a real-world view as seen through the transparent planar waveguides 12 or 22. Although the near-eye display systems are depicted with single planar waveguides, the display systems may also comprise multiple planar waveguides in a stacked format for separately conveying images in different colors or different portions of the images. In a more general sense, the image light guides contemplated herein through which virtual images can be directed to a wearer's eye can take various forms and can include a variety of ways for in-coupling and out-coupling light into and out of a waveguide while still supporting views of the ambient environment through the waveguide. That is, both the out-coupling optic and the waveguide itself should be constructed to not unduly interfere with the wearer's view of the ambient environment through the waveguide. Both virtual objects as conveyed by the image light guide and real-world objects that are seen through the image light guide should be clearly visible to the wearer to support further interactions of the wearer with the ambient environment such as may be informed by the superimposed virtual content. In addition, the image light guides contemplated herein may include an out-coupling diffractive optic operable to provide two-directional expansion of the eyebox. The refractive index variations along a first direction of the out-coupling diffractive optic can be arranged to diffract a portion of each beam's energy out of the waveguide upon each encounter therewith through a desired first order of diffraction, while another portion of the beam's energy is preserved for further propagation in its original direction through a zero order of diffraction. The refractive index variations along a second direction of the out-coupling diffractive optic can be arranged to diffract a portion of each beam's energy upon each encounter therewith through a desired first order of diffraction in a direction angled relative to the beam's original direction of propagation, while another portion of the beam's energy is preserved for further propagation in its original direction through a zero order of diffraction. In such an embodiment, the image light guide may, or may not, include a turning optic while providing two-directional expansion of the eyebox.

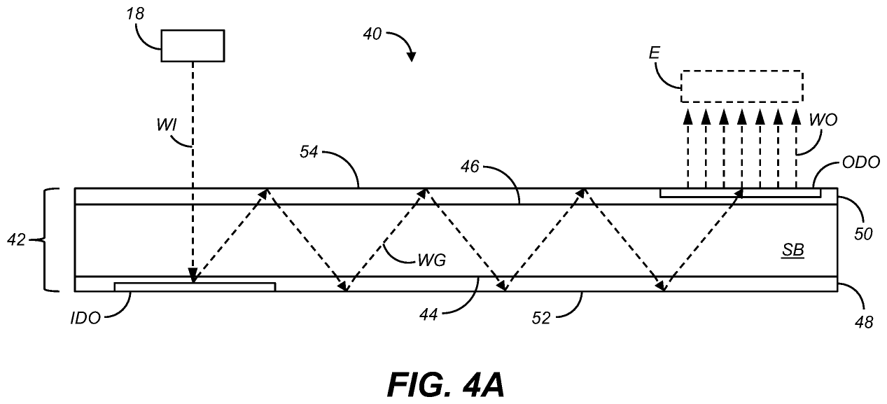

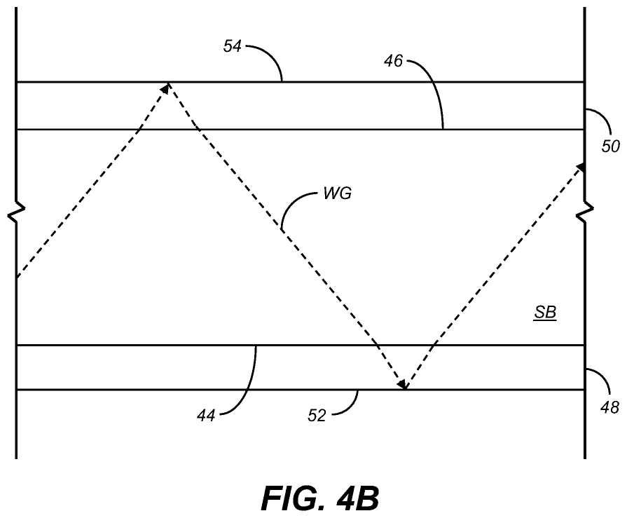

The side view of FIG. 4A shows an embodiment of an image light guide 40 which can be arranged in a similar way to any of the arrangements described for the image light guides 10, 20, or 30. In an example embodiment, image light guide 40 does not include an optional intermediate turning optic. However, instead of forming a planar waveguide as a base substrate S with a given refractive index n and front and back surfaces exposed to air, the planar waveguide 42 of the image light guide 40 is formed as a composite structure with a base substrate SB having a refractive index nᵢ sandwiched between outer layers 48 and 50, both having a refractive index nₑ that exceeds the refractive index nᵢ. The higher index outer layers 48 and 50 provide a higher refractive index interface with the surrounding air and influence the design and performance of the diffraction gratings, such as may be used in any one or more of an in-coupling diffractive optic IDO, turning optic TO, and an out-coupling diffractive optic ODO.

For example, the higher refractive indices of the outer layers 48 and 50 exposed to air support total internal reflection within the planar waveguide 42 at lower angles of incidence, which reduces the average angle of diffraction required by the in-coupling and out-coupling diffractive optics IDO and ODO for coupling the angularly related beams WI into the planar waveguide 42 and for coupling the angularly encoded image-bearing light beams WG out of the planar waveguide 42. In addition, the depth of the diffractive features of the diffractive optics IDO, TO, and ODO, such as, without limitation, grooves, can be reduced (as compared to diffractive features in a lower refractive index material) because of the larger refractive index difference between the higher index outer layers 48 and 50 and the surrounding air. Front and back surfaces 52 and 54 of the higher index layers 48 and 50 preserve the desired optical smoothness, flatness, and parallelism of the front and back surfaces 44 and 46 of the substrate SB to avoid modifying the angular content of the propagating image-bearing light beams WG. As illustrated in FIG. 4A and FIG. 4B, the angularly encoded image-bearing light beams WG experience refraction at the front and back surfaces 44 and 46 of the substrate SB.

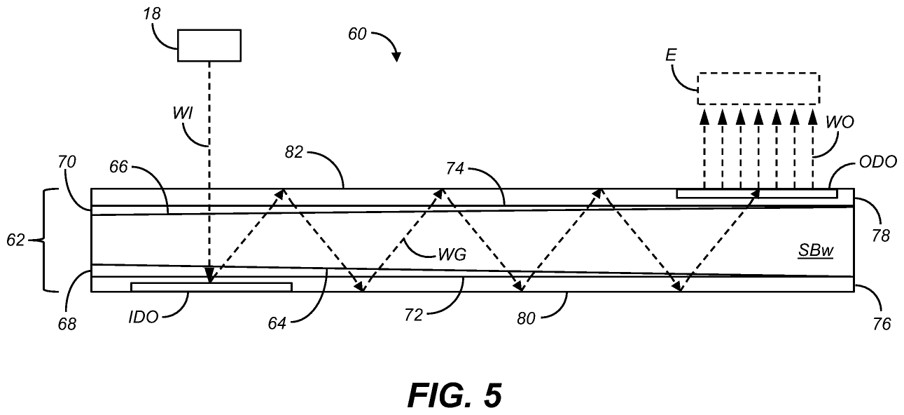

Alternatively, if the front and back surfaces 44 and 46 of the base substrate SB, depart from being optically smooth, flat, or parallel, an index matched layer can be used to correct or compensate for these departures. Referring to FIG. 5, there is shown an alternative image light guide 60 having a composite planar waveguide 62. Here, a base substrate SBw is wedge shaped, so that its front and back surfaces 64 and 66 are not sufficiently in parallel for propagating the image-bearing light beams WG without angular modification. To correct for this discrepancy in surface orientation, intermediate layers 68 and 70 are fashioned as inverted wedges on the substrate SBw and are formed from a material having a refractive index that matches the refractive index nᵢ of the base substrate SBw. Together, the base substrate SBw and intermediate layers 68 and 70 restore the desired parallelism for propagating the image-bearing light beams WG without angular modification. The intermediate layers 68 and 70 also allow the base substrate SBw to be made to less exacting standards for optical smoothness, flatness, and parallelism, which can reduce cost. Whether as a result of departures from smoothness, flatness, or parallelism in the front and back surfaces 64 and 66 of the base substrate SBw, the intermediate layers 68 and 70 can be complementarily fashioned so that the front and back surfaces 72 and 74 of the intermediate layers 68 and 70 exhibit the desired smoothness, flatness, and parallelism.

The composite planar waveguide 62 of the image light guide 60 is also formed with outer layers 76 and 78 having refractive index nₑ that exceeds the common refractive index nᵢ of the base substrate SBw and the intermediate layers 68 and 70. The in-coupling and out-coupling diffractive optics IDO and ODO are formed in or on the outer layers 76 and 78 to provide the same advantages as provided by the outer layers 48 and 50 of the image light guide 40 of FIG. 4A. For example, the differential depths of the diffractive features can be less because of the higher refractive index of the outer layers 76 and 78 and the average amount of angular diffraction can be less because of the lower incidence angles at which TIR can be supported within the outer layers 76 and 78. A turning optic, as a diffractive optic formed in or on one of the outer layers 76 and 78, would also accrue similar advantages. Front and back surfaces 80 and 82 of the outer layers 76 and 78 are formed optically smooth, flat, and parallel matching the form of the front and back surfaces 72 and 74 of the intermediate layers to support the desired propagation of the image-bearing light beams WG without angular modification.

The base substrates SB or SBw can be made of standard glass, plastic, or other conventional optically transmissive materials having a refractive index that is common for such widely available materials, generally at 1.6 or less, and does not add unnecessary expense or impose unusual design requirements. However, among these materials, the material of the base substrate SB or SBw can be selected to correspond with one of the available index matching materials suitable for forming the intermediate layers 68 and 70. Both the intermediate layers 68 and 70 and the outer layers 48 and 50 or 76 and 78 can be formed as transparent coatings made of polymers or cements, including epoxy resins, so that when cured, exhibit sufficient adhesion and dimensional stability to maintain the desired smoothness, flatness, and parallelism of the planar waveguides 42 or 62. The coating materials selected for the intermediate layers 68 and 70 have a refractive index matching the refractive index of the base substrate SBw under expected operating conditions, and the coatings selected for the outer layers 48 and 50 or 76 and 78 have a refractive index that is significantly higher, e.g., generally greater than 1.6 and preferably greater than or equal to 1.7. Among candidate coating polymers for the intermediate layers are various acrylic-urethane materials and thermosetting polyurethanes, for example. Various polymides and hybrid polymers with additives can be used for the outer layers. The diffractive optics of the in-coupling and out-coupling diffractive optics IDO and ODO, as well as any diffractive optic of the turning optic TO, can be formed in or on the outer layers 76 and 78.

Among the higher index materials, a higher index material can be chosen for the outer layers 48 and 50 or 76 and 78 that has increased hardness to resist scratching or other adverse environmental influences. The higher index outer layers 48 and 50 or 76 and 78 also have the effect of blocking external light at high incidence angles or low grazing angles from entering the waveguides 42 or 62 as stray light. In addition, the high index outer layers 48 and 50 or 76 and 78 can themselves be formed a plane parallel optical substrates that can be adhered by an index matching material directly or indirectly to the base substrates SB or SBw.

The various embodiments can utilize diffractive or reflective components internal or external and connected to the mostly parallel surfaces of the waveguide for in-coupling, out-coupling, or internally redirecting ray bundles that comprise a virtual image. Such waveguides can also be comprised of different materials, with different optical characteristics, provided those materials are transparent to the light being guided by the waveguide and that the interfaces between such materials having different indices of refraction remain parallel to both the surfaces of the waveguide and any buried boundaries where the index of refraction changes.

As diffractive optics, the in-coupling, turning, and out-coupling optics can be formed with ruled profiles that are imprinted on or in any of outer layers 48 and 50 or 76 and 78 such as by etching or replication from master gratings. The periodic diffractive features of the profiles can be formed as grooves in or on the outer layers 48 and 50 or 76 and 78 and the remaining profile is preferably formed by the same high index material. The higher refractive index material contrasted with the surrounding air allows the grooves or other features with differential depths to be formed with a shallower depth. In addition, the higher index material can increase grating efficiency and allow for expanding grating performance over a wider ranges of angles and wavelengths. Whether formed in or on the outer layers 48 and 50 or 76 and 78 with the higher refractive index material, the gratings are preferably spaced apart from the interface between the lower and higher index materials so that refraction at this interface can reduce the amount of diffraction required for directing light into or out of the waveguide.

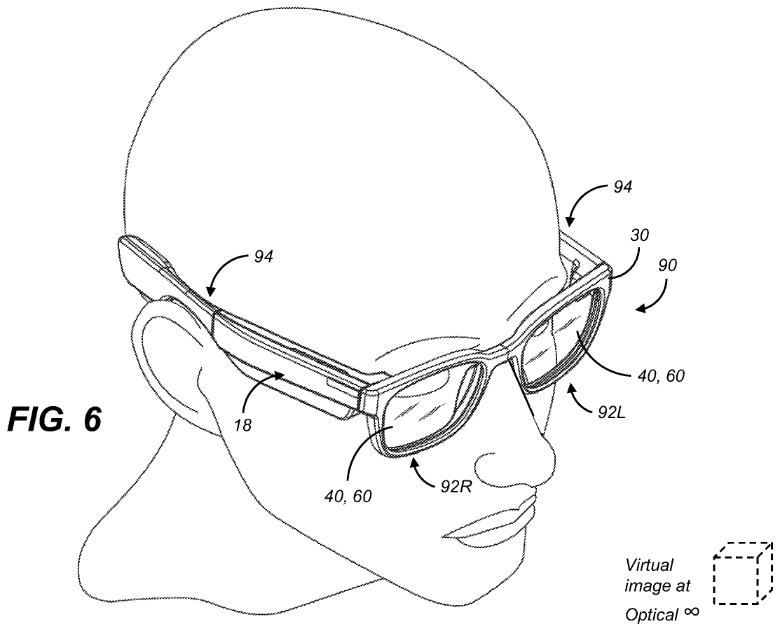

The perspective view of FIG. 6 shows an example embodiment of an augmented reality near-eye display system 90 for mounting on a viewer's head. In one example embodiment, the augmented reality near-eye display system 90 is operable to provide three-dimensional (3-D) augmented reality viewing using one or more image light guides 40, 60. Augmented reality near-eye display system 90 is shown as an HMD with a left-eye optical system 92L having one or more image light guides 40, 60 for the left eye, and a corresponding right-eye optical system 92R having one or more image light guides 40, 60 for the right eye. Augmented reality near-eye display system 90 includes image source systems 100, each mounted along a temple member 94 of a frame of augmented reality near-eye display system 90, where the augmented reality near-eye display system 90 takes the form of glasses 30. The glasses 30, in one example embodiment, are configured in such a way to resemble conventional eye-wear (e.g., ophthalmic eyeglasses). Although augmented reality near-eye display system 90 is illustrated as a binocular system, i.e., a system with an image source system for the left eye and a second image source system for the user's right eye, respectively, it should be appreciated that the present disclosure applies equally to monocular systems, i.e., systems with only one image source system for either the user's left or right eye. Similarly, although augmented reality near-eye display system 90 is illustrated as a “smart glasses” system, it should be appreciated that the present disclosure applies equally to Heads-Up Displays (HUDs) with different positioning of the image source system 100. In an example embodiment, the image source system 100 includes one or more projectors, e.g., an LCD, LCoS, or DLP projector system that is energizable to emit a respective set of angularly related beams. In another example embodiment the image source system 100 includes a self-emitting micro display that includes a plurality of individually addressable image light sources, e.g., LEDs or OLEDs. In one example, the plurality of individually addressable light sources form a two-dimensional array of micro LEDs (uLEDs). The images that are generated can be a stereoscopic pair of images for 3-D viewing. The virtual images that are formed can appear to be superimposed or overlaid onto the real-world scene content seen by the wearer. Additional components familiar to those skilled in the augmented reality visualization arts, such as one or more cameras mounted on the frame of the HMD for viewing scene content or viewer gaze tracking, can also be provided.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. An image light guide for a near-eye display system, comprising:
a planar waveguide including (a) a transmissive substrate having a first refractive index and (b) at least one outer layer of transmissive material having a second refractive index, wherein the second refractive index is higher than the first refractive index,
wherein the transmissive substrate includes a front surface and a back surface, and
wherein the at least one outer layer of a transmissive material is engaged with at least one of the front and back surfaces of the transmissive substrate; and
at least one of an in-coupling optic and an out-coupling optic formed in or on the at least one outer layer of transmissive material, wherein the at least one of the in-coupling optic and the out-coupling optic is operable to couple image-bearing light beams into or out of the planar waveguide.

2. The image light guide of claim 1, wherein the at least one outer layer of transmissive material includes a first outer layer engaged with the front surface of the transmissive substrate and a second outer layer supported of transmissive material engaged with the back surface of the transmissive substrate.

3. The image light guide of claim 2, wherein the at least one of the in-coupling optic and the out-coupling optic comprise diffractive features.

4. The image light guide of claim 2, wherein the first and second outer layers include respective front and back parallel surfaces.

5. The image light guide of claim 4, wherein the front and back surfaces of the first and second outer layers contain parallel surfaces exposed to air.

6. The image light guide of claim 1, wherein at least one of the front and back surfaces of the transmissive substrate depart from being at least one of optically smooth, flat, and parallel, and wherein the at least one of the front and back surfaces further comprise at least one intermediate layer of a transmissive material having a refractive index matching the first refractive index of the transmissive substrate and comprise at least one of a front intermediate surface and a back intermediate surface that is optically smooth, flat, and parallel.

7. The image light guide of claim 6, wherein the at least one intermediate layer is located between the transmissive substrate and the at least one outer layer.

8. The image light guide of claim 7, wherein the at least one intermediate layer includes a first intermediate layer adjacent to the front surface of the transmissive substrate and a second intermediate layer adjacent to the back surface of the transmissive substrate, and the first and second intermediate layers include respective front and back intermediate surfaces that are optically smooth, flat, and parallel.

9. The image light guide of claim 8, wherein the at least one outer layer includes a first outer layer adjacent to the front intermediate surface of the first intermediate layer and a second outer layer adjacent to the back intermediate surface of the second intermediate layer, and the first and second outer layers include respective front and back surfaces that are optically smooth, flat, and parallel.

10. The image light guide of claim 1, wherein the refractive index of the transmissive substrate is 1.6 or less and the refractive index of the at least one outer layer is greater than or equal to 1.7.

11. The image light guide of claim 1, wherein the at least one of the in-coupling and out-coupling optics is a diffraction grating having diffractive features formed at differential depths in or on the at least one outer layer and is spaced apart from an interface between the transmissive substrate and the at least one outer layer such that refraction at the interface reduces the amount of diffraction required for directing light into or out of the waveguide.

12. An image light guide for a near-eye display system, comprising:
a planar waveguide,
an in-coupling optic, and
an out-coupling optic, wherein the in-coupling and out-coupling optics, are operable to direct image-bearing light beams into and out of the planar waveguide, respectively;
the planar waveguide including a transmissive substrate having front and back surfaces, at least one intermediate layer of a transmissive material adhered to at least one of the front and back surfaces of the transmissive substrate, and at least one outer layer of a transmissive material adhered to the at least one intermediate layer;
the at least one intermediate layer having a refractive index that matches a refractive index of the transmissive substrate; and
the at least one outer layer having a refractive index that is greater than the matching refractive index of the at least one intermediate layer and the transmissive substrate.

13. The image light guide of claim 12, wherein at least one of the front and back surfaces of the transmissive substrate depart from being at least one of optically smooth, flat, and parallel, and the at least one intermediate layer has at least one of a front intermediate surface and a back intermediate surface that is optically smooth, flat, and parallel to compensate for the departure of the at least one of the front and back surfaces of the transmissive substrate.

14. The image light guide of claim 13, wherein the at least one intermediate layer includes a first intermediate layer adhered to the front surface of the transmissive substrate and a second intermediate layer adhered to the back surface of the transmissive substrate, and the first and second intermediate layers include respective front and back intermediate surfaces that are optically smooth, flat, and parallel.

15. The image light guide of claim 12, wherein the at least one outer layer includes a first outer layer adhered to the front intermediate surface of the first intermediate layer and a second outer layer adhered to the back intermediate surface of the second intermediate layer, and the first and second outer layers include respective front and back outer surfaces that are optically smooth, flat, and parallel.

16. The image light guide of claim 12, wherein the refractive index of the transmissive substrate and the at least one intermediate layer is 1.6 or less and the refractive index of the at least one outer layer is greater than 1.6.

17. The image light guide of claim 16, wherein the refractive index of the at least one outer layer is greater than 1.7.

18. A method of making an image light guide for a near-eye display, the method comprising:
coating a transmissive substrate having a first refractive index with at least one outer layer of transmissive material having a second, higher, refractive index, wherein the transmissive substrate and the at least one outer layer of transmissive material form a planar waveguide; and
forming at least one of an in-coupling diffractive optic and an out-coupling diffractive optic in or on the at least one outer layer of transmissive material.

19. The method of claim 18, wherein the at least one of the in-coupling and out-coupling diffractive optics is a diffraction grating having diffractive features formed at differential depths in or on the at least one outer layer and is spaced apart from an interface between the lower and higher refractive index materials so that refraction at the interface reduces the amount of diffraction required for directing light into or out of the waveguide.

20. The method of claim 18, wherein the step of coating includes coating the transmissive substrate with at least one intermediate layer having a refractive index matching the refractive index of the transmissive substrate and then coating the at least one intermediate layer with the at least one outer layer so that one or more interfaces between the at least one outer layer and the at least one intermediate layer are formed parallel to one or more outer surfaces of the one or more outer layers.
